(19) United States
(12) Patent Application Publication
(10) Pub. No.: US 2020/0287813 A1
(43) Pub. Date: Sep. 10, 2020

(54) METHOD AND APPARATUS FOR WORKLOAD FEEDBACK MECHANISM FACILITATING A CLOSED LOOP ARCHITECTURE

(71) Applicants: Patrick Kutch, TIGARD, OR (US); John Browne, LIMERICK (IE); Shobhi Jain, SHANNON (IE); Jasvinder Singh, SHANNON (IE); Sunku Ranganath, BEAVERTON, OR (US); Adrian Hoban, CASTLEBAR (IE); Swati Sehgal, SHANNON (IE); Killian Muldoon, SHANNON (IE); Tarun Viswanathan, EL DORADO HILLS, CA (US); Khawar Abbasi, SHANNON (IE)

(72) Inventors: Patrick Kutch, TIGARD, OR (US); John Browne, LIMERICK (IE); Shobhi Jain, SHANNON (IE); Jasvinder Singh, SHANNON (IE); Sunku Ranganath, BEAVERTON, OR (US); Adrian Hoban, CASTLEBAR (IE); Swati Sehgal, SHANNON (IE); Killian Muldoon, SHANNON (IE); Tarun Viswanathan, EL DORADO HILLS, CA (US); Khawar Abbasi, SHANNON (IE)

(21) Appl. No.: 16/850,277

(22) Filed: Apr. 16, 2020

(51) Int. Cl. H04L 12/26; H04L 12/24

(52) U.S. Cl. CPC H04L 43/0817; H04L 43/0882; H04L 41/5019; H04L 43/06; H04L 43/16

(57) ABSTRACT

Methods and apparatus for workload feedback mechanisms facilitating a closed loop architecture. Platform telemetry data is collected from a server platform including one or more hardware components and running one or more virtual network functions (VNFs). A workload performance associated one or more VNFs or one or more applications associated with the one or more VNFs is monitored to detect whether the performance of a VNF or application fails to meet a performance criteria, such as a Service Level Agreement (SLA) metric, and corresponding performance indicia is generated by the VNF. Based on the platform telemetry data and the performance indicia, an operational configuration of one of more of the hardware components is adjusted to increase the workload performance to meet or exceed the performance criteria. The apparatus may comprise a system employing distributed processing including the server platform hosting telemetry collection and VNF(s), an analytics system to analyze the platform telemetry data and performance indicia, and a management component (e.g., MANO) to adjust the configuration of the one or more hardware components.

### BACKGROUND INFORMATION

Deployment of Software Defined Networking (SDN) and Network Function Virtualization (NFV) has also seen rapid growth in the past few years. Under SDN, the system that makes decisions about where traffic is sent (the control plane) is decoupled for the underlying system that forwards traffic to the selected destination (the data plane). SDN concepts may be employed to facilitate network virtualization, enabling service providers to manage various aspects of their network services via software applications and APIs (Application Program Interfaces). Under NFV, by virtualizing network functions as software applications, network service providers can gain flexibility in network configuration, enabling significant benefits including optimization of available bandwidth, cost savings, and faster time to market for new services.

NFV decouples software (SW) from the hardware (HW) platform. By virtualizing hardware functionality, it becomes possible to run various network functions on standard servers, rather than purpose built HW platform. Under NFV, software-based network functions run on top of a physical network input-output (IO) interface, such as by NIC (Network Interface Controller), using hardware functions that are virtualized using a virtualization layer (e.g., a Type-1 or Type-2 hypervisor or a container virtualization layer).

A goal of NFV is to be able to place multiple VNFs (Virtualized Network Functions) on a single platform and have them run side-by-side in an optimal way without disrupting each other; adding more traditional workload that run next to those VNF's is another significant goal of the industry. However, these goals have been elusive to obtain in practice.

With an ever growing number of VNFs that run on a variety of infrastructures (for example VMware, KVM, OpenStack, Kubernetes, OpenShift) it becomes very difficult for integrators to understand the effects of running multiple VNF's and workloads may have on each other in regards to meeting service level agreement (SLA's), attesting to the security posture of the platform and workloads and such. One result of these difficulties is that the norm in the industry is to run a single VNF appliance on a single platform, which results in increased inter-platform communication, increased platform costs, and reduced resource utilization.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating an overview of a workload feedback mechanism facilitating a closed loop architecture, according to one embodiment;

FIG. 2 is a schematic diagram illustrating further details of workload aspects of closed loop architecture of FIG. 1, according to one embodiment;

FIG. 3 is a schematic diagram illustrating an exemplary deployment architecture, according to one embodiment;

FIG. 4 is a schematic diagram illustrating a deployment architecture comprising an example instantiation for the deployment architecture of FIG. 3 using Kubernetes;

FIG. 5 is a flowchart illustrating operations and logic implemented by deployment architectures of FIGS. 3 and 4, according to one embodiment;

FIG. 6 is a flowchart illustrating operations and logic implemented by embodiments of deployment architectures presented herein to implement a closed loop architecture, according to one embodiment;

FIG. 7 is a schematic diagram illustrating an architecture for an exemplary implementation of a firewall VNF with a closed-loop feedback;

FIG. 8 is a schematic diagram illustrating an architecture for an exemplary implementation of a firewall VNF with a closed-loop feedback employing a host telemetry microservice;

FIG. 9 is a flowchart illustrating operations performed by the host telemetry microservice and associated components, according to one embodiment; and

FIG. 10 is a schematic diagram of a server platform configured to implement aspects of the server platforms described and illustrated herein.

### DETAILED DESCRIPTION

Embodiments of methods and apparatus for workload feedback mechanisms facilitating a closed loop architecture are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

An area of growing interest to cloud service providers, customers, and equipment vendors is the use of platform telemetry to help in analyzing the interactions of multiple workloads. Examples of this include the Intel® Performance Monitoring Unit (Intel® PMU) and Intel® Resource Director Technology (Intel® RDT) telemetry capabilities; which expose a great deal of telemetry on a per-core basis that includes, but not limited to how much of the various cache levels are being utilized by the core, cache misses, hits, memory bandwidth and much more. Other processor vendors, such as AMD® and ARM®-based processor vendors have likewise introduced telemetry capabilities.

Under aspects of the embodiments disclose herein, the workloads themselves participate in publishing the metrics by which they are affected most to a host telemetry microservice. This microservice is specific to the VNF and carries out the correlation between the telemetry specific to the workload, platform PMU metrics and the indicators. This indicator is then sent to an analytic system that analyze it along with overall platform PMU and makes appropriate recommendation to a management/orchestration entity (e.g., MANO) like suggesting MANO to spawn additional service or migrating them.

Recent activities have shown that CPU Core frequencies can be scaled in order to achieve significant power savings for a specific DPDK (Dataplane Development Kit) based workload; the standard operating system (OS)-based frequency managers do not work for DPDK applications because the core is always at 100% utilization by the nature of DPDK Poll mode driver (DPDK PMDs). Under embodiments and implementation is able to detect actual business of the DPDK PMD based upon some PMU telemetry; so in this instance the core frequency can be scaled based upon PMU telemetry data in order to save power, which is of significant importance to some VNF customers.

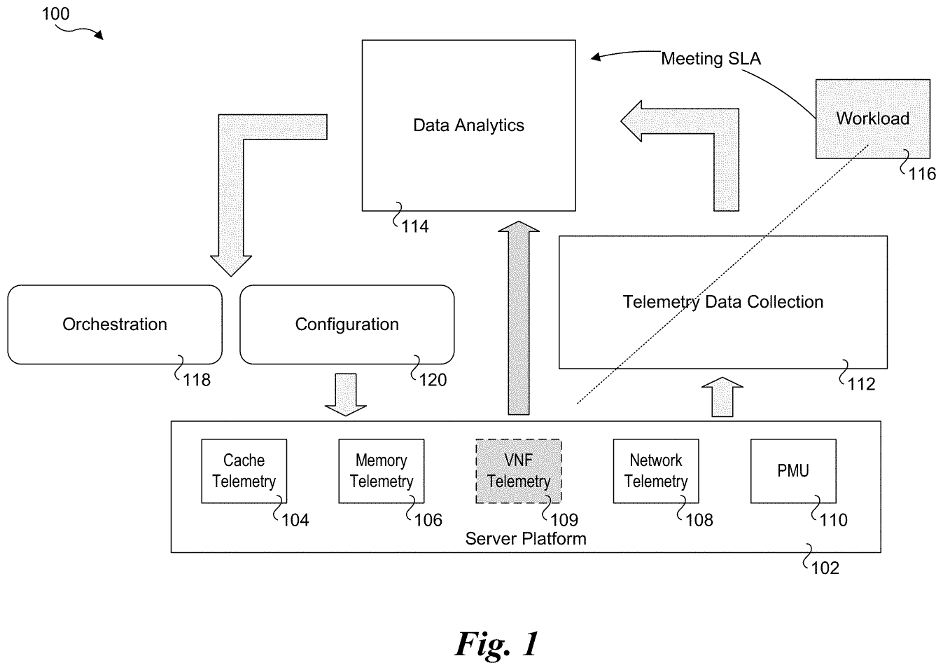

FIG. 1 shows an overview of a workload feedback mechanism facilitating a closed loop architecture 100. Architecture 100 includes a server platform 102 that included multiple means for generating telemetry data, including cache telemetry logic 104, memory telemetry logic 106, network telemetry logic 108, and PMU 110. The telemetry data generated by the foregoing and other potentially other telemetry data sources (not shown) are collected by a telemetry data collection mechanism 112 that provides telemetry data input to a data analytics block 114. Telemetry data is also generated by or collected from a VNF and/or applications, as depicted by VNF telemetry 109 and a workload 116, and forwarded to data analytics block 114. Data analytics block 114 performs data analytics processing of its inputs and provides output data to an orchestration block 118 and a configuration block 120, which, in turn, provide control inputs to server platform 102 to adjust hardware operations on the server platform.

Today the platform telemetry collection mechanism most commonly used is collectd, and, accordingly, in one embodiment telemetry data collection mechanism 112 uses collectd. Collectd uses plugins for collecting a configurable number of metrics from server platforms and publishes the collected metrics to an analytics component, such as data analytics block 114. The analytics component uses the telemetry information in conjunction with the application telemetry (e.g., VNF telemetry 109) to potentially make changes to the platform (such as core frequency scaling or cache allocation) or to indicate to a scheduler to move a workload, for example.

To achieve the targeted level of automation, the workload/application/VNF participates in the telemetry exposure process. With as simple of a telemetry indication of ‘Meeting SLA’ or ‘Not Meeting SLA’ (e.g., as represented by a ‘1’ or ‘0’), an analytic component will be able to analyze platform and OS telemetry to attempt to find the optimal conditions for the workload. If the telemetry provided by the workload can provide additional reasons as to why it may or may not be meeting SLA's then the analytic component may be able to do an even better job at narrowing down the corresponding platform telemetry.

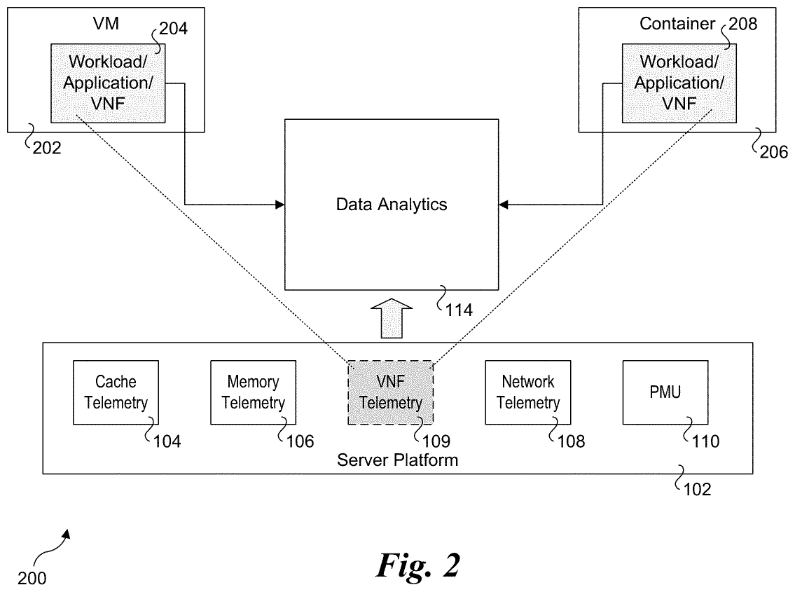

FIG. 2 shows a diagram 200 illustrating further details of workload aspects of closed loop architecture 100. In addition to the components shown in FIG. 1 and discussed above, diagram 200 further shows a VM 202 in which a workload/application/VNF 204 is run and a container 206 in which a workload/application/VNF 208 is run. More generally, a given platform host multiple VMs or containers in which workloads/applications/VNFs are run. As depicted, data analytics block 114 receives input from each of workload/application/VNF 204 and 208.

Generally, the particular mechanisms by which telemetry and associated data are exposed and in what form the data are exposed is beyond the scope of this disclosure. One or more known mechanisms may be implemented, which may further employ secure network connections and/or out-of-band connection. Platform capabilities such as Hardware Queue Manager (HQM) may also be employed.

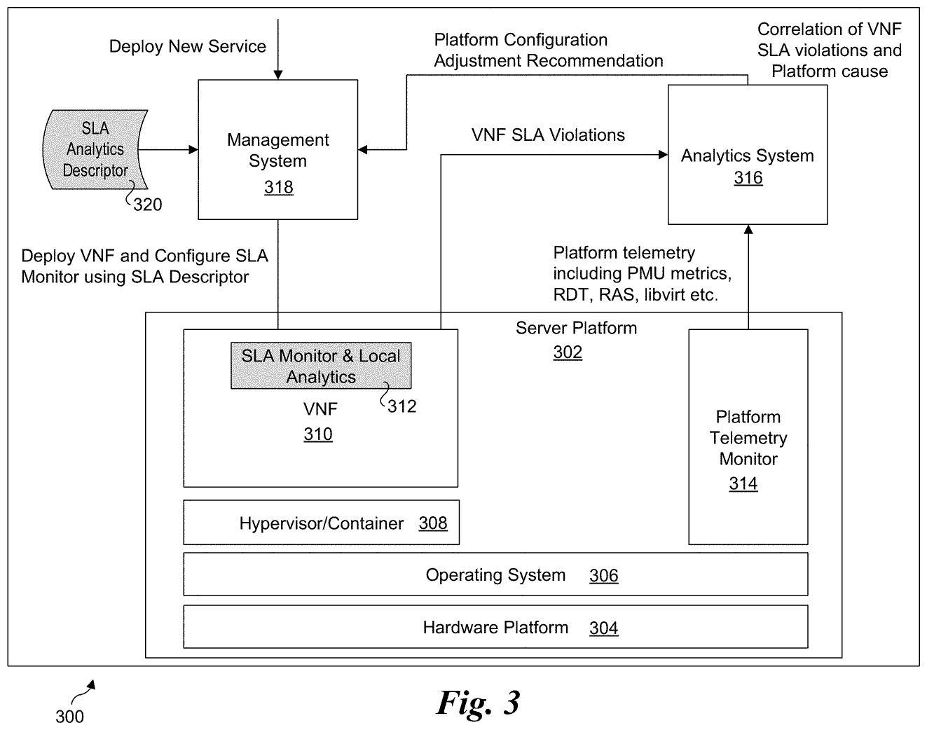

FIG. 3 shows an exemplary deployment architecture 300 including a server platform 302, and analytics system 316, and a management system 318. Server platform 302 includes a hardware platform 304, and operating system 306, a hypervisor/container abstraction layer 308, a VNF 310, and a platform telemetry monitor 314. VNF 312 includes an SLA monitor and local analytics component 312.

As shown in FIG. 3, a request to deploy a new service is provided to management system 318. The new service represents a new workload that is to be implemented as or using VNF 310. When the workload is launched it is provided with information on how to send the workload/application/VNF telemetry data and some sort of schema for the format of the data, as depicted by an SLA analytics descriptor 320. In one embodiment, SLA analytics descriptor 320 represents 1) VNF metrics to monitor; 2) thresholds/integration periods and combination rules for analysis and triggers to generate violations; and 3) location(s) to report violations.

Deployment architecture 300 generally operates as follows. During ongoing operations, platform telemetry data, such as PMU metrics, Intel® Resource Director Technology (RDT), reliability, availability, serviceability (RAS) data, libvirt data (for Linux platforms), etc., are collected from various telemetry sources by platform telemetry monitor 314 and published to analytics system 316. SLA monitor and analytics component 312 monitors the SLA metrics for VNV 310 and reports the VNF SLA violations to analytics system 316. Analytics system 316 performs data analytics to determine a correlation of VNF SLA violations and platform causes to determine a platform configuration adjustment recommendation, which is provided as an input to management system 318. Management system 318 then provides control inputs to server platform 302 to effect adjustment of the operational configuration of one or more hardware components, such as increasing core frequencies.

Generally, SLA monitor and local analytics component 312 can be implemented as software or hardware or a combination of both. In one embodiment, SLA monitor and local analytics component 312 comprises a host telemetry microservice. In one embodiment, SLA monitor and local analytics component 312 1) receives SLA analytics descriptor 320; 2) periodically monitors VNF metrics based on the rules provided by the descriptor; 3) forwards SLA violations when detected to analytics system 316; and 4) accepts changes to the analytics descriptor in the case of scaling events or other management requested changes.

The VNF SLA violation indicator provides insights that the VNF is operating normally and meeting SLA status or failing to meet SLA status. Optionally, the VNF violation indicator may provide an indication of how well the SLA is being met. For example: 98% SLA compliance. As VNF 310 scales in/out or up/down, management system 318 can issue an SLA analytics descriptor configuration update to SLA monitor and local analytics component 312 or the host telemetry microservice, which will apply the new rules to determine SLA compliance.

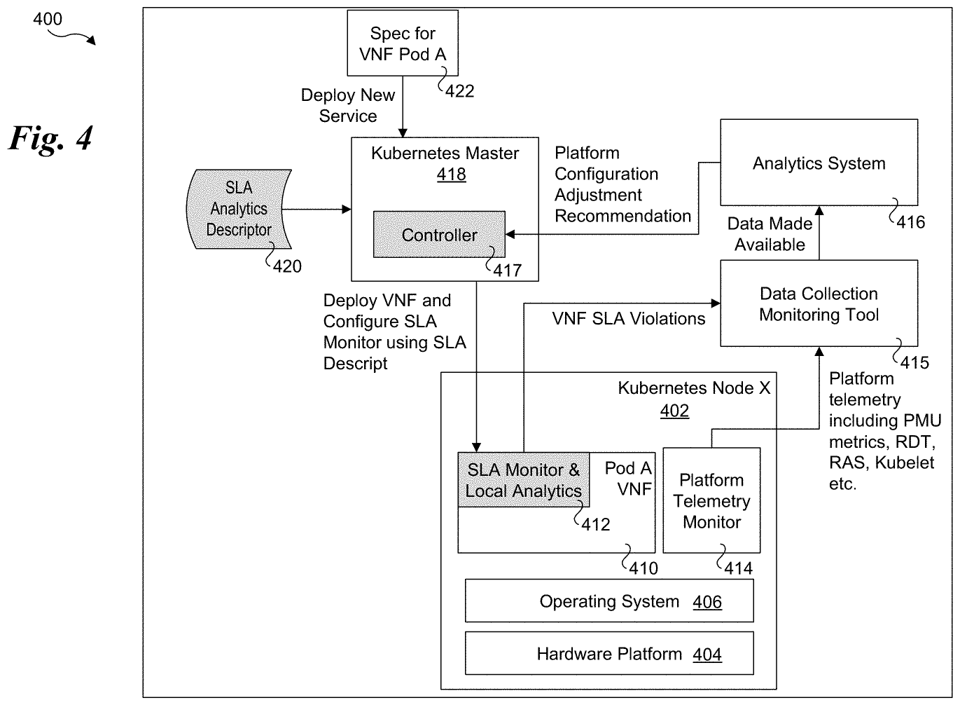

FIG. 4 shows a deployment architecture 400 comprising an example instantiation for deployment architecture 300 in Kubernetes. Under Kubernetes nomenclature, a Kubernetes pod is a group of containers that are deployed together on the same host, (e.g., the same physical server). A pod is the basic execution unit of a Kubernetes application. A pod encapsulates an application's container (or multiple containers), storage resources, a unique network IP, and options that govern how the container(s) should run. A pod represents a unit of deployment: a single instance of an application in Kubernetes, which might consist of either a single container or a small number of containers that are tightly coupled and that share resources.

Deployment architecture 400 includes a Kubernetes node 402 implemented on hardware platform 404 and in which an operating system 406, a VNF 410 including an SLA monitor and local analytics component 412 and a platform telemetry monitor 414 are run or deployed. Platform telemetry monitor 414 provides (e.g., via publication) platform telemetry data such as PMU metrics, RDT, RAS, Kubelet, etc. to a data collection monitoring tool 415. Data collection monitoring tool 415 also receives information identifying VNF SLA violations from SLA monitor and analytics component 412. Data collection monitoring tool 415 makes these data available to an analytics system 416, which performs analytics analysis on these data and outputs a platform configuration adjustment recommendation that is sent to a controller 417 in a Kubernetes master 418.

As further shown in FIG. 4, a new service is deployed by providing a specification 422 for the VNF to be deployed on Pod A to Kubernetes master 418, which also receives an SLA analytics descriptor 420. Kubernetes master 418 uses these inputs to deploy the VNF and configured SLA monitoring using the SLA descriptor.

In one embodiment, The SLA Analytics Descriptor 420 represents 1) a Kubernetes custom resource; 2) VNF metrics to monitor; and 3) Thresholds/integration periods and combination rules for analysis and triggers that generate violations. In one embodiment, controller 417 represents 1) Kubernetes custom controller watching SLA Analytics Descriptors; 2) Integrates with Kubernetes Control plane; 3) Location(s) to report violations; 4) Communicates SLA Monitor descriptors to SLA Monitor and local analytics on pod; 5) Updates SLA Monitor descriptors when required; and 6) Logical solution of rules from SLA Analysis Descriptor to identify violations.

SLA Monitor and local analytics component 412 or a host telemetry container is deployed with the application in the pod. For example, it may be deployed as a sidecar container or native component. SLA Monitor and local analytics component 412 or a host telemetry container 1) Receives the SLA Analytics descriptor from controller; 2 Periodically monitors VNF metrics based on the rules provided by the descriptor; 3) Forwards violations to Data Collection & Monitoring tool when detected; and 4) Accepts changes to the analytics descriptor in the case of scaling events or other management requested changes.

As above, the VNF SLA violation indicator provide insights that the VNF is operating normally and meeting SLA status or failing to meet SLA status. Optionally a VNF SLA violation may provide an indication of how well the SLA is being met, such as 98% SLA compliance.

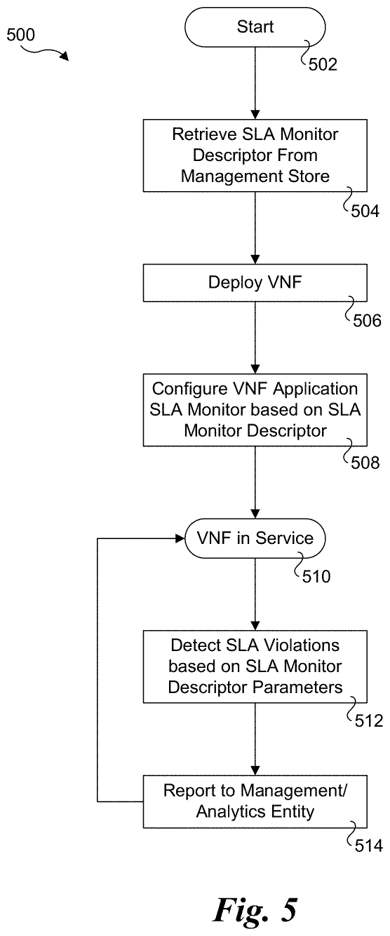

FIG. 5 shows a flowchart 500 illustrating operations and logic implemented by deployment architectures 300 and 400, according to one embodiment. The flow begins in a start block 502. In a block 504 the SLA monitor descriptor is retrieved from a management store. The SLA monitor descriptor and other applicable deployment configuration information is used to deploy the VNF in a block 506. In a block 508, the VNF application SLA monitor is configured based on the SLA monitor descriptor.

Once the VNF is deployed and the VNF application SLA monitor is configured, the VNF is in service, as shown in a start block 510. In a block 512, SLA violations are detected based on the SLA monitor descriptor parameters. In a block 514, an SLA violation is reported to a management entity and/or or analytics entity. As depicted by the loop back to star block 510, the operations of blocks 512 and 514 are performed in an ongoing matter while the VNF is in service.

Generally, the platform configuration adjustment recommendation may include information to enable management system to address the VNF SLA violation by adjusting platform hardware, such as frequencies of processor cores.

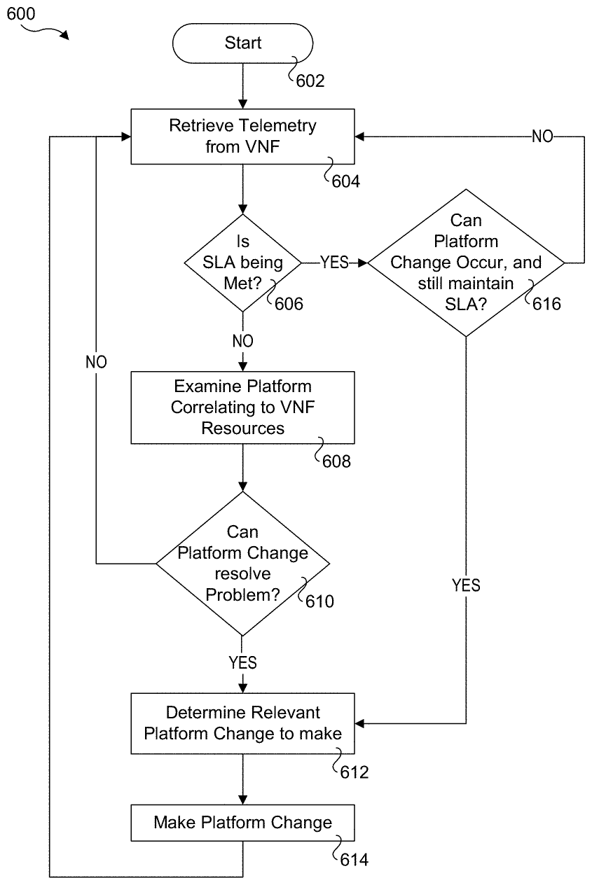

FIG. 6 shows a flowchart illustrating operations and logic implemented by embodiments of deployment architectures presented herein to implement a closed loop architecture. Following a start block 602, telemetry data is retrieved from a VNF in a block 604. In a decision block 606 a determination is made to whether one or more applicable SLA metrics is being met. If the answer is NO, the logic proceeds to a block 608 in which platform correlation to VNF resources is examined.

Next, in a decision block 610, a determination is made to whether a change in platform configuration can resolve the problem. If the answer is YES, the logic proceeds to a block 612 in which a relevant platform change to make is determined, followed by making the platform change in a block 614.

Returning to decision block 606, if the SLA is being met the logic proceeds to a decision block 606 to determine whether a platform change can be made while still maintaining the SLA performance criteria (e.g., performance metric(s)). For example, it may be desirable to reduce power consumption by lowering the frequency of one or more processor cores. If the answer to decision block 616 is YES, the logic proceeds to block 612, and the operation of blocks 612 and 614 are performed to determine and implement the platform change. If the answer to decision block 616 is NO, the logic loops back to block 604. Similarly, if it is determined in decision block 610 that a platform change can't be made to resolve the problem (leading to the SLA violation), the logic returns to block 604.

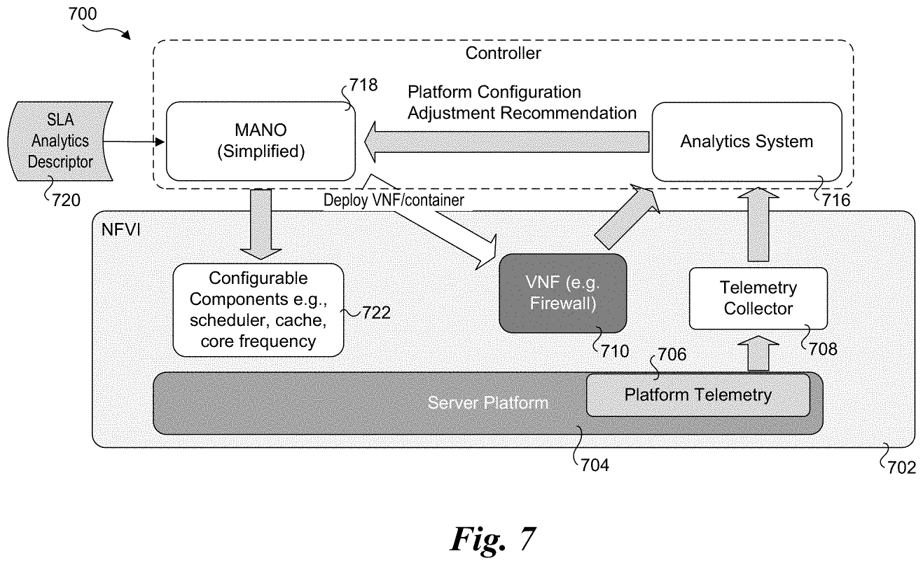

FIG. 7 shows an architecture 700 illustrating an exemplary implementation of the firewall VNF with a closed-loop feedback. Architecture 700 employs an NFVI (Network Functions Virtualized Infrastructure) 702 having hardware in including a server platform 704 with one or more components generating platform telemetry 706 and software components including a telemetry collector 708 and a firewall VNF 710. Architecture 700 further includes an analytics system 716 and a MANO 718.

Initially, firewall VNF 710 is deployed by MANO 718 using SLA analytics descriptor 720 in a similar manner to that described above. During ongoing operations, telemetry collector 708 collects telemetry data from platform telemetry 708 and provides (e.g., publishes) the collected telemetry data to analytics system 716. Firewall VNF 710 also provides performance indicia such as an SLA general indication of SLA performance to analytics system 716. Analytics system processed its inputs to produce a platform configured adjustment recommendation that is provided to MANO 718. MANO 718 then provides configuration inputs 722 to adjust the configuration of applicable components on server platform 704.

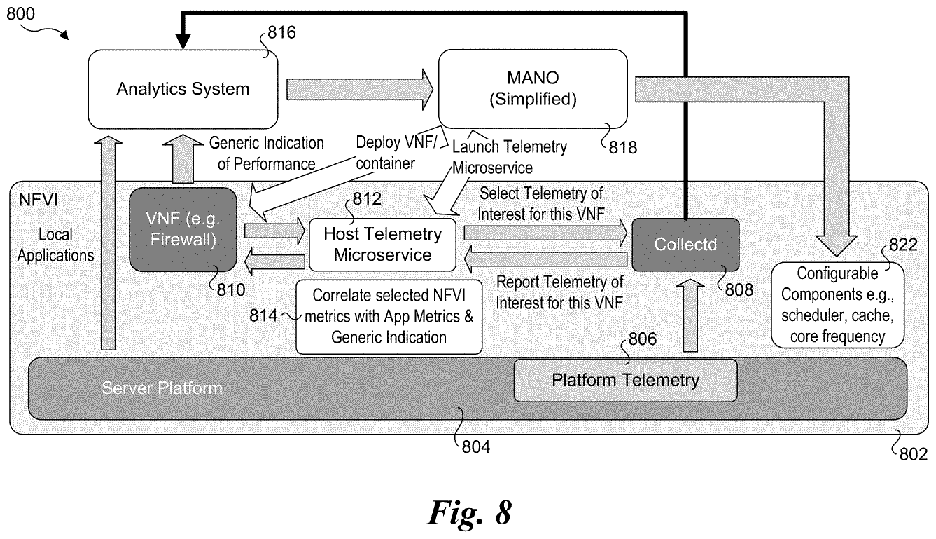

FIG. 8 shows an architecture 800 depicting a more detailed implementation of architecture 700 employing a host telemetry microservice. NFVI 802 employs hardware including a server platform 804 with one or more components generating platform telemetry 806. The software components include collectd 808, firewall VNF 810, and a host microservice 812. Architecture 800 also includes an analytics system 816 and a MANO 818.

Under an aspect of the method, workloads themselves participate in publishing the metrics by which they are affected most to the host telemetry microservice (e.g., host telemetry microservice 812). In one embodiment, the host telemetry microservice is specific to the VNF and carries out the correlation between the telemetry specific to the workload, platform PMU metrics and the indicators, as depicted in a block 814. In one embodiment a generic indication of performance is calculated or otherwise determined by host telemetry microservice 812, and forward the generic indication to the analytics system (816) via the VNF (810). The analytics system will analyze the generic indication along with overall platform telemetry data (e.g., PMU metrics) from collectd 808 and makes appropriate recommendation to a management/orchestration entity (e.g., MANO) like suggesting MANO to spawn an additional service or migrating them.

Consider a deployment of firewall VNF 810 that is mainly interested in an ‘SLA violation’ scenario. While deploying the firewall VNF, MANO 818 will deploy host telemetry microservice 812 based on the SLA analytics descriptor (not shown but similar to SLA analytics descriptor 720 in FIG. 7). The deployed microservice will then select the specific NFVI telemetry for firewall VNF 812 from collectd 808. Collectd 8008 will now report only the selected NFVI telemetry to host telemetry microservice 812. The host telemetry microservice will then correlate the selected NFVI metrics with the application metrics, e.g., firewall VNF metrics and the generic indication. For example, if the host telemetry microservice analyzes packets that are getting dropped due to an SLA violation that is detected, it will provide a generic indication such as ‘0’ (bad) or ‘SLA Violated’ to the VNF, which will further communicate it to the analytics system. The analytic system will analyze the generic indication with overall platform metrics collected by collectd 808 and will make appropriate recommendations such as spawn a new VNF or migrate the service to a new VM.

Generally, the generic indication can be: 1 or 0 (Good or bad) or a number between 0 and 100, to indicate relative performance (e.g., 0% or 100%), or it can be a message related to performance such as ‘Not meeting my SLA’/‘Meeting my SLA’. The generic indication can represent, for example: capacity, throughput, latency, etc. It could also be represented by xml such as <generic performance indication name><Integer range>. Also, the proposed microservice here can be deployed for each new VNF. Optionally, the host telemetry microservice can be ‘generic’ and a service/VNF specific plugin can be installed by the management system. As another option, the correlating of selected NFVI metrics with application metrics and the generic indication operation can also be done in the VNF itself, depending upon the performance sensitivity of the VNF.

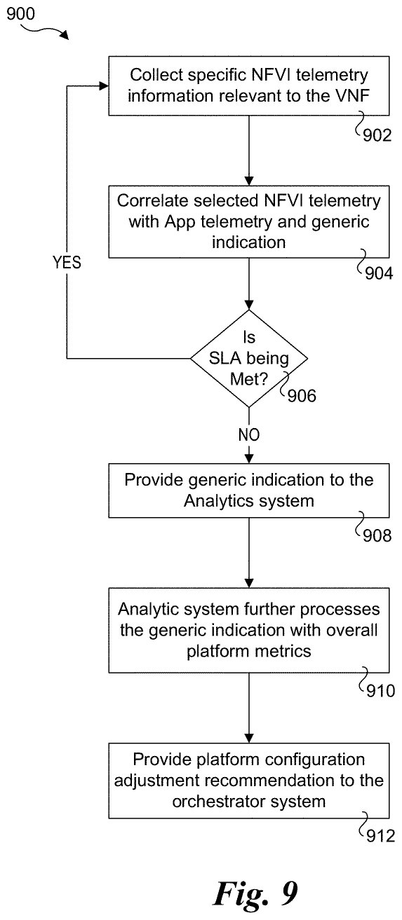

FIG. 9 shows a flowchart 900 illustrating operations performed by the host telemetry microservice and associated components, according to one embodiment. In a block 902 specific NFVI telemetry information relevant to the VNF is collected. As depicted in a block 904 and a decision block 906, selected NFVI telemetry is combine with application telemetry information to detect a generic indication. If the SLA is not being met, the answer to decision block 906 is NO, and the logic proceeds to a block 908 in which the generic indication is provided to the analytics system. In a block 910 the analytic system further process the generic indication with overall performance metrics received from the telemetry collector (e.g., collectd) and provided a configuration adjustment recommendation to the orchestration system (e.g., MANO) in a block 912.

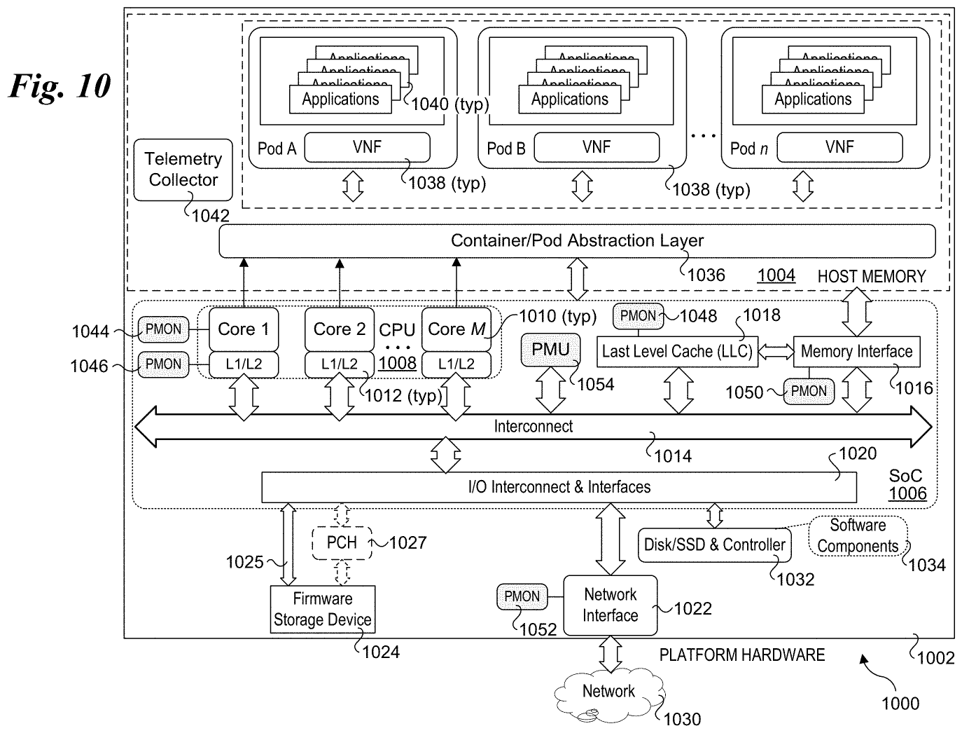

FIG. 10 shows an embodiment of a server platform architecture 1000 suitable for implementing aspects of the embodiments described herein. Architecture 1000 includes a hardware layer in the lower portion of the diagram including platform hardware 1002, and a software layer that includes software components running in host memory 1004. Platform hardware 1002 includes a processor 1006 having a System on a Chip (SoC) architecture including a central processing unit (CPU) 1008 with M processor cores 1010, each coupled to a Level 1 and Level 2 (L1/L2) cache 1012. Each of the processor cores and L1/L2 caches are connected to an interconnect 1014 to which a memory interface 1016 and a Last Level Cache (LLC) 1018 is coupled, forming a coherent memory domain. Memory interface is used to access host memory 1004 in which various software components are loaded and run via execution of associated software instructions on processor cores 1010.

Processor 1006 further includes an Input/Output (I/O) interconnect hierarchy, which includes one or more levels of interconnect circuitry and interfaces that are collectively depicted as I/O interconnect & interfaces 1020 for simplicity. Various components and peripheral devices are coupled to processor 1006 via respective interfaces (not all separately shown), including a network interface 1022 and a firmware storage device 1024. In one embodiment, firmware storage device 1024 is connected to IO interconnect via a link 1025, such as an Enhanced Serial Peripheral Interface Bus (eSPI). As an option, firmware storage device 1024 may be operatively coupled to processor 1006 via a platform controller hub (PCH) 1027.

Network interface 1022 is connected to a network 1030, such as a local area network (LAN), private network, or similar network within a data center. For example, various types of data center architectures may be supported including architecture employing server platforms interconnected by network switches such as Top-of-Rack (ToR) switches, as well as disaggregated architectures such as Intel® Corporation's Rack Scale Design architecture.

Platform hardware 1002 may also include a disk drive or solid-state disk (SSD) with controller 1032 in which software components 1034 are stored. Optionally, all or a portion of the software components used to implement the software aspects of embodiments herein may be loaded over a network 1030 accessed by network interface 1022.

The software components illustrated in FIG. 10 include a container/pod abstraction layer 1036 used to host n pods Pod A, Pod B, . . . Pod n, each including an VNF 1038 implementing one or more applications 1040. In one embodiment, the Pods are Kubernetes Pods. Platform architectures employing containers, such as Docker®-type containers, may be implemented in a similar manner. Optionally, platform architectures employing VMs may be implemented using a Type-1 (bare metal) or Type-2 Hypervisor or VMM. The software components also include a telemetry collector 1042.

As further illustrated in FIG. 10, platform hardware 1002 includes various components for generating telemetry data, as depicted by PMONs (performance monitors) 1044, 1046, 1048, 1050, 1052 and a PMU 1054. Examples of telemetry data include but are not limited to processor core telemetry data, cache-related telemetry data, memory-related telemetry data, network telemetry data, and power data. The cache-related telemetry data may include but is not limited to Cache Monitoring Technology (CMT), Cache Allocation Technology (CAT), and Code and Data Prioritization (CDP) telemetry data. CMT monitors LLC utilization by individual threads, applications, VMs, VNFs, etc. CMT improves workload characterization, enables advanced resource-aware scheduling decisions, aids “noisy neighbor” detection and improves performance debugging. CAT enables software-guided redistribution of cache capacity, enabling VMs, containers or applications to benefit from improved cache capacity and reduced cache contention. CDP is an extension of CAT that enables separate control over code and data placement in the LLC. Certain specialized types of workloads may benefit with increased runtime determinism, enabling greater predictability in application performance.

In one embodiment, PMON 1050 implements Memory Bandwidth Monitoring (MBM). MBM enables multiple VMs, VNFs, or applications to be tracked independently, which provides memory bandwidth monitoring for each running thread simultaneously. Benefits include detection of noisy neighbors, characterization and debugging of performance for bandwidth-sensitive applications, and more effective non-uniform memory access (NUMA)-aware scheduling.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Italicized letters, such as ‘n’ and ‘M’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by a processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
while running one or more virtual network functions (VNFs) on a server platform including platform hardware comprising a plurality of hardware components,
collecting platform telemetry data generated by the server platform;
monitoring workload performance associated with work performed by at least one of the one or more VNFs or one or more applications associated with the one or more VNFs;
detecting a workload performance of a VNF or application fails to meet a performance criteria, and in response thereto generating corresponding performance indicia; and
adjusting, based on the platform telemetry data and the performance indicia, an operational configuration of one of more of the hardware components to increase the workload performance to meet or exceed the performance criteria.

2. The method of claim 1, further comprising:
providing the platform telemetry data that is collected to an analytics system;
providing the performance indicia to the analytics system; and
generating, via the analytics system and based on the platform telemetry data and the performance indicia, a platform configuration adjustment recommendation,
wherein the platform configuration adjustment recommendation is used to adjust the operational configuration of one or more of the hardware components to increase the workload performance to meet or exceed the performance criteria.

3. The method of claim 2, further comprising:
providing the platform configuration adjustment recommendation to a management component; and
adjusting, via the management component, the operational configuration of one or more of the hardware components to increase the workload performance to meet or exceed the performance criteria.

4. The method of claim 1, wherein the hardware components including a plurality of processor cores and adjusting the operational configuration of the one of more of the hardware components comprises increasing a frequency of at least one of the plurality of processor cores.

5. The method of claim 1, wherein the corresponding performance indicia comprises a generic indication indicating a service level agreement (SLA) metric is not being met.

6. The method of claim 5, further comprising:
receiving an SLA analytics descriptor defining one or more SLA metrics to be monitored; and
deploying a VNF configured to monitor the one or more SLA metrics through use of the SLA analytics descriptor.

7. The method of claim 1, further comprising:
implementing a host telemetry microservice;
correlating, with the host telemetry microservice, telemetry data collected from the platform hardware and application telemetry data obtained from a VNF or one or more applications associated with the VNF; and
determining, based on the correlation, whether the performance criteria is being met.

8. The method of claim 7, further comprising:
providing an input from the host telemetry microservice to a telemetry collector identifying selected telemetry information of interest to the VNF; and
providing, via the telemetry collector to the host telemetry microservice, telemetry information corresponding to the selected telemetry information of interest to the VNF.

9. The method of claim of claim 1, further comprising:
implementing the one or more VNFs in a respective pod;
for at least one pod,
implementing a Service Level Agreement (SLA) monitor and local analytics to detect an SLA performance level violation; and, in response thereto
generating corresponding performance indicia indicating the SLA performance level violation.

10. A system comprising:
Network Functions Virtual Infrastructure (NFVI) including,
a server platform having one or more hardware components configured to generate platform telemetry data;
a telemetry collector, configured to collect platform telemetry data generated by the one or more hardware components;
at least one virtual network function (VNF) configured to run on the server platform to perform a respective workload and generate performance indicia indicative of a workload performance level of the VNF; and
an analytics system, configured to,
receive or access platform telemetry data collected by the telemetry collector and the performance indicia generated by the at least one VNF; and
provide a platform configuration adjustment recommendation to be used to adjust the configuration of at least one of the one or more hardware components based on analysis of the platform telemetry data and the performance indicia.

11. The system of claim 10, wherein the performance indicia is a generic indicator indicating a performance level of a VNF is not being met, and wherein the platform configuration adjustment recommendation is used to adjust the configuration of the at least one of the one or more hardware components to increase the performance level of the VNF to meet the performance level.

12. The system of claim 10, further comprising a management and orchestration component (MANO) configured to receive the platform configuration adjustment recommendation from the analytics system and provide one or more control inputs to the server platform to adjust the configuration of at least one of the one or more hardware components in the server platform.

13. The system of claim 12, wherein the MANO is further configured to:
receive or access a Service Level Agreement (SLA) analytics descriptor defining one or more of,
a) VNF metrics to monitor; and
b) one or more of thresholds, integration periods and combination rules for analysis and triggers that generate SLA violations; and
deploy a VNF and configure the VNF to generate SLA performance indicia defined by the SLA analytics descriptor.

14. The system of claim 10, further comprising a host telemetry microservice configured to:
correlate telemetry data collected from the platform hardware and application telemetry data obtained from a VNF or one or more applications associated with the VNF; and
determine, based on the correlation, whether the performance criteria is being met.

15. The system of claim 10 of claim 14, wherein the host telemetry microservice is configured to provide an input to the telemetry collector identifying selected telemetry information of interest to a VNF, and wherein the telemetry collector is configured to provide telemetry information to the host telemetry microservice corresponding to the selected telemetry information of interest to the VNF.

16. A non-transitory machine-readable storage medium having instructions comprising a plurality of software components configured to be executed in a distributed environment include a first server platform having platform hardware comprising a plurality of hardware components, wherein the plurality of software components include:
a platform telemetry monitor, configured to be executed on the first server platform and configured to collect platform telemetry data generated by the first server platform and provide or publish collected platform telemetry data to one of a data collection monitoring tool or an analytics system;
a first Virtual Network Function (VNF), configured to,
perform a workload via execution on the first server platform;
monitor workload performance; and
generate performance indicia based on the monitored workload performance; and
provide the performance indicia to one of the data collection monitoring tool or the analytics system; and
the analytics system, configured to,
receive or access platform telemetry data collected by the platform telemetry monitor and receive or access the performance indicia generated by the first VNF; and
provide a platform configuration adjustment recommendation to be used to adjust the configuration of at least one of the one or more hardware components on the first server platform based on analysis of the platform telemetry data and the performance indicia.

17. The non-transitory machine-readable storage medium of claim 16, wherein the plurality of software components further include one of a master or management and orchestration component (MANO) configured to receive the platform configuration adjustment recommendation from the analytics system and provide one or more control inputs to the server platform to adjust the configuration of at least one of the one or more hardware components in the server platform.

18. The non-transitory machine-readable storage medium of claim 17, wherein the master or MANO is further configured to:
receive or access a Service Level Agreement (SLA) analytics descriptor defining one or more of,
a) VNF metrics to monitor; and
b) one or more of thresholds, integration periods and combination rules for analysis and triggers that generate SLA violations; and
deploy the first VNF and configure the first VNF to generate SLA performance indicia defined by the SLA analytics descriptor.

19. The non-transitory machine-readable storage medium of claim 18, wherein the first VNF includes an SLA monitor and local analytics component that is configured to:
monitor the workload performance of the first VNF in view of the SLA analytics descriptor to detect a VNF SLA violation; and, in response to detection of an VNF SLA violation; and
generate performance indicia indicating a VNF SLA violation has occurred and forwarding the performance indicia to one of the data collection monitoring tool and the analytics system.

20. The non-transitory machine-readable storage medium of claim 16, wherein the plurality of software components include multiple Kubernetes components, wherein the first VNF comprises a VNF pod, and wherein the VNP pod and platform telemetry monitor are implemented in a Kubernetes node hosted by the server platform.
